(19) United States
(12) Patent Application Publication
(10) Pub. No.: US 2006/0047449 A1
(43) Pub. Date: Mar. 2, 2006

(54) Graphical test development tool for use with automated test equipment

(75) Inventors: Steven L. Petersen, Yorba Linda, CA (US); Tyler L. Tolman, Laguna Niguel, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 10/927,474

(22) Filed: Aug. 27, 2004

(51) Int. Cl. G06F 19/00

(52) U.S. Cl. 702/68; 702/124

(57) ABSTRACT

A method for displaying data received from automated testing equipment is disclosed. The method includes the steps of receiving data output from automated testing equipment, processing a predetermined integer number of samples of the received data, displaying the predetermined integer number of samples on a graph, the graph showing magnitudes of the samples versus a time scale, and wrapping additional samples of the received data on top of the displayed graph to provide an eye pattern. The eye pattern allows for evaluation of the data output from the automated testing equipment.

### BACKGROUND OF THE INVENTION

1. Field of the Invention

The present invention relates to apparatuses and methods for providing a graphical test of results. In particular, the present invention is directed to means for presenting data received from Automated Test Equipment in a useful format for evaluation.

2. Description of Related Art

Automated Test Equipment (ATE) is computer controlled test and measurement equipment. The equipment is used to provide testing of a unit with minimal human interaction. The testing process is readably repeatable and cost efficient in high volume. Some of the disadvantages of ATE testing are the upfront costs, which are often associated with programming and setup.

Automated test equipment can test components, printed circuit boards, and interconnections. Test types for components include logic, memory, linear or mixed signal, passive components and active components. Typically testing is done by the application of a test current. Printed circuit board testers include manufacturing defect analyzers, in-circuit testers, and functional analyzers. Test types for interconnection and verification include cable and harness testers and bare-board testers. Bare board automated test equipment is used to detect the completeness of a PCB circuit before assembly and wave solder.

Configurations for automated test equipment include bed-of-nails (BON), flying probe, and optical. In a bed-of-nails configuration each circuit net on the board is connected to the tester, typically with one nail per net. The flying probe system uses a low number of moving probes rather than the high number of fixed probes in the BON. Optical inspection methods include scanning probe microscopes to reveal surface defects. Common features for automated test equipment include boundary-scan capabilities, temperature control, and support of STDF, Standard Test Data Format.

Currently, many types of ATE use real-time digitizers because of their speed advantages over sampling oscilloscopes. If the output of the ATE is applied to a sampling oscilloscope, the real-time data is taken and wrapped based on a real-time trigger signal frequency. This has the effect of creating what is called an “eye” diagram. From this eye-diagram, useful information can be either subjectively gathered at a glance or precisely measured using mathematical equations.

However, providing such analysis requires bringing a sampling oscilloscope to the test site. Without such a sampling oscilloscope, it can be difficult to determine whether there is a problem with the signal being produced from the ATE. Thus, there is a need in the prior art for a system to provide the analysis that is possible through the use of a sampling oscilloscope without requiring the sampling oscilloscope. There is also a need for a system that provides for later analysis of the data produced to quickly determine problems in the output data from the ATE.

### SUMMARY OF THE INVENTION

According to one embodiment of the invention, a method for displaying data received from automated testing equipment is disclosed. The method includes the steps of receiving data output from automated testing equipment, processing a predetermined integer number of samples of the received data, displaying the predetermined integer number of samples on a graph, the graph showing magnitudes of the samples versus a time scale, and wrapping additional samples of the received data on top of the displayed graph to provide an eye pattern. The eye pattern allows for evaluation of the data output from the automated testing equipment.

Additionally, the data received may be through a file having ASCII values output from the automated testing equipment or through an electronic signal output from the automated testing equipment. Also, the step of enabling evaluation of the displayed eye pattern can include enabling color indications in the displayed eye pattern to indicate a population of data points at a pixel position in the displayed eye pattern.

In addition, the step of enabling evaluation of the displayed eye pattern may include enabling measurement of values based on the displayed eye pattern in a real-time manner. The values measured include a jitter value for the data received from the automated testing equipment or a voltage swing for the data received from the automated testing equipment. Also, the step of wrapping additional samples may be performed such that the performance of a scanning oscilloscope is emulated.

According to another embodiment, a display system for data received from automated testing equipment is disclosed. The tool includes receiving means for receiving data output from automated testing equipment, processing means for processing a predetermined integer number of samples of the received data, displaying means for displaying the predetermined integer number of samples on a graph, the graph showing magnitudes of the samples versus a time scale, re-displaying means for wrapping additional samples of the received data on top of the displayed graph to provide an eye pattern and evaluation means for enabling evaluation of the displayed eye pattern.

According to another embodiment, a computer program product stored on a computer readable medium executable to perform method steps for displaying data received from automated testing equipment. The method step performed include receiving data output from automated testing equipment, processing a predetermined integer number of samples of the received data, displaying the predetermined integer number of samples on a graph, the graph showing magnitudes of the samples versus a time scale, wrapping additional samples of the received data on top of the displayed graph to provide an eye pattern and enabling evaluation of the displayed eye pattern.

These and other variations of the present invention will be described in or be apparent from the following description of the preferred embodiments.

### BRIEF DESCRIPTION OF THE DRAWINGS

For the present invention to be easily understood and readily practiced, the present invention will now be described, for purposes of illustration and not limitation, in conjunction with the following figures:

FIG. 1 provides a schematic of an automated testing equipment setup, according to one embodiment of the present invention;

FIG. 2 illustrates the “eye” diagram produced from data output from the ATE, according to one embodiment of the present invention;

FIG. 3 provides a display based on one embodiment of the present invention;

FIG. 4 provides a display based on one embodiment of the present invention;

FIG. 5 illustrates a flowchart for the processing of data output from an ATE, according to one embodiment of the present invention; and

FIG. 6 illustrates a process of analyzing displayed data, with FIG. 6(a) illustrating cross-hair for defining points on the display and FIG. 6(b) providing a datalog showing measurements based on the defined points.

### DETAILED DESCRIPTION OF PREFERRED EMBODIMENTS

Currently, most Automated Test Equipment (ATE) uses real-time digitizers because of their speed advantages over sampling scopes. While there are prior art tools available to view the digitized waveform data on an ATE, they only allow one to view the data real-time. More importantly, this restriction does not permit the advantages of a sampling oscilloscope. It is largely impossible to visually analyze the signal quality of captured signals without the capabilities of a sampling oscilloscope.

Sampling oscilloscopes take the real-time data and wrap it based on a real-time trigger signal frequency. This has the effect of creating what is called an “eye” diagram. From this eye-diagram, useful information can be either subjectively gathered at a glance or precisely measured using mathematical equations.

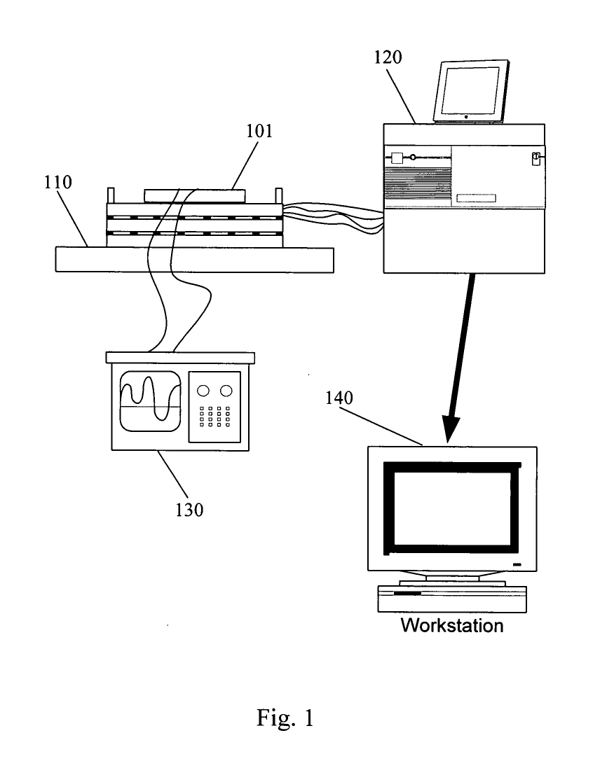

FIG. 1 illustrates a typical ATE setup. The setup includes a test bed 110 that allows for mounting of the unit 101 that is being tested. As discussed above, the ATE unit can be any type of ATE, including bed-of-nails, flying probe, or optical and the unit being tested may be a component or a printed circuit board. The test bed 110 is connected to a computational portion 120 of the ATE that is used to provide test signals and to monitor the results from the unit being tested. The data from the computational portion 120 may be sent to a workstation 140 for further evaluation. If a sampling oscilloscope 130 is used with the testing, then separate connections to the unit being tested or the test bed are usually made.

Information, that can be visually obtained by a sampling oscilloscope, but are difficult to see with current digitizer viewing technologies, include jitter, minimum and maximum voltage swings, overshoot and undershoot, setup and hold times of clock to data if two channels are used simultaneously, Eye quality (known as a Q factor), Voltage Controlled Oscillator (VCO) locking, ISI (Inter-Symbol Interference) and Signal intensity.

During the ATE test development process, it is typically required that multiple communication signal measurements be acquired and analyzed. It is not always practical or possible to connect an external scope to an ATE due to access limitations to the hardware. Furthermore the only signal quality that is even relevant is the signal seen by the actual ATE equipment and not the signal seen by an external scope because the external scope will not be used during actual device testing.

In one embodiment, the present invention is designed to take an ASCII wave file from any Automated Test Equipment (ATE) digitizer and display the results based on the exact period of the capture. This results in folding the waveform data back onto itself creating what is called an “eye” diagram. In other embodiments, the resulting data output by the ATE may be directly input into the present invention, instead of using a file structure. Additionally, the present invention allows for evaluation of output data at distant locations and at later times. For example, if the testing is being established in a foreign country, only the wave file need to be forwarded for evaluation and thus distant evaluation can be enabled.

The present invention can have many benefits in its various embodiments. Included in these benefits are the elimination of the need to connect an oscilloscope to the device-under-test, the ability to analyze various parameters of the signal-under-test, and the ability to correlate the Automated Test Equipment results to the results of the present invention. Therefore, the required solution is a tool to view these digitized captured waveforms in a manner that mimics a sampling oscilloscope and also correlates to the ATE test program.

Some advantages of the present invention include: reducing test development time because the root problem of the signal is quickly visible, improving the quality of the ATE test program by providing a method to correlate to the ATE test program results, and eliminating the burden of using an external oscilloscope. The present invention can provide therefore for a standalone device or tool that can be used either on-line while operating the ATE or off-line from the ATE so as not to unnecessarily utilize ATE tester time.

In one embodiment, the present invention can take an ASCII wave file from a digitizer, such as the Catalyst/Tiger “Gigadig”, and display the results based on the exact period of the capture. This provides for a folding of the wave data back onto itself resulting in an “eye” diagram just like an oscilloscope would do. The present invention eliminates the need to connect a scope to the device, allows for analysis of various parameters of the signal, such as jitter, eye opening, and allows for correlation of the ATE results with the display of the present invention.

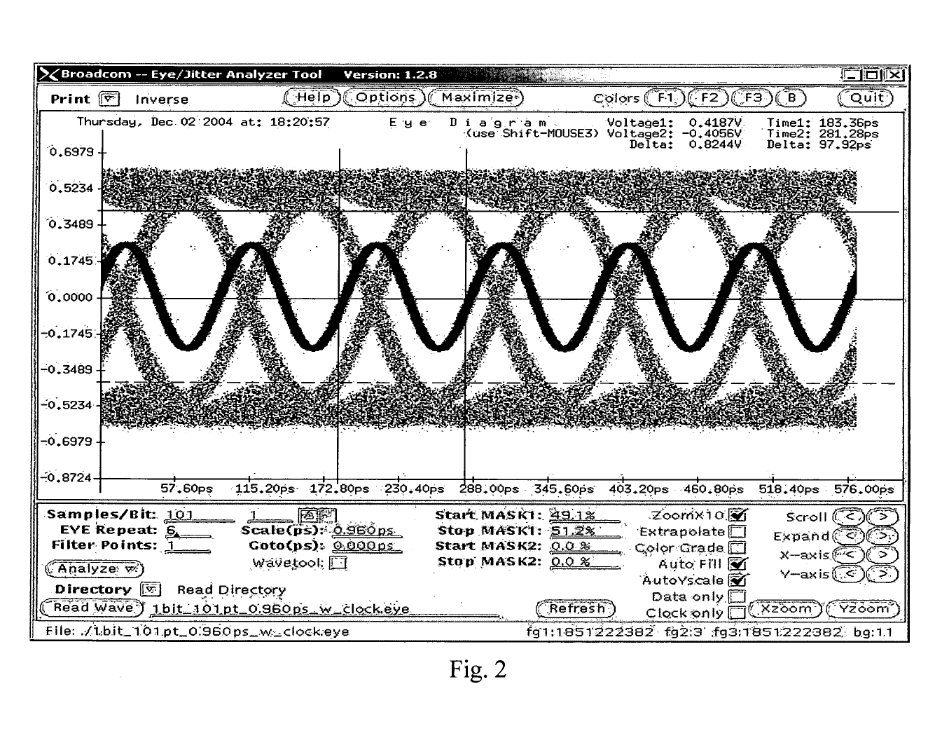

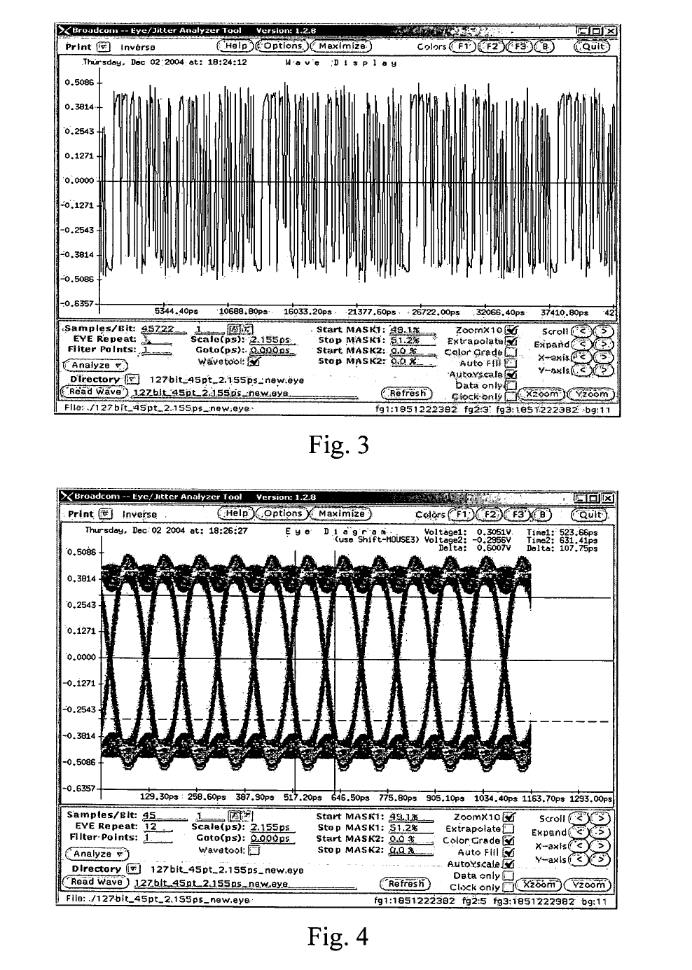

An example of one such “eye” diagram is provided in FIG. 2. The Y axis of the graph provides a magnitude of sample values contained in the data received from the ATE and the X axis provides a time scale. The vertical bars illustrated can be manipulated to provide evaluation of the displayed data. Additionally, FIG. 3 provides a wave display of the data received from the ATE, with FIG. 4 providing an “eye” diagram for the same data. As may be understood, making determinations from the displayed wave form data is much more difficult than evaluating the “eye” diagram. The visual characteristics of the “eye” diagram provide an immediate check on the integrity of the data being received from the ATE.

The operation of the present invention can include many options. These options can include setting the integer number of data points captured in a period of the data and the number of times to repeat the data. The operation of the present invention also includes point filtering, where the number of points to look ahead and back when integrating the waveform can be set. The present invention can also allow the time value of each data point in the waveform file to be set, as well as setting the starting point of the waveform. The present invention can allow for the data to be viewed without folding and masking ranges to allow extraneous data to be ignored. These masking ranges can determined automatically.

In addition, the present invention can also allow for extrapolation between data points. The color grade of the display can also be set, in particular embodiments, so that the waveform color can be set to indicate a population of data in that area. The display area can also be changed to zoom in or out along a particular axis, or expand a single section of the displayed waveform. The present invention also allows for the display to retrace the data with a new color to more easily indicate drift in the capture process.

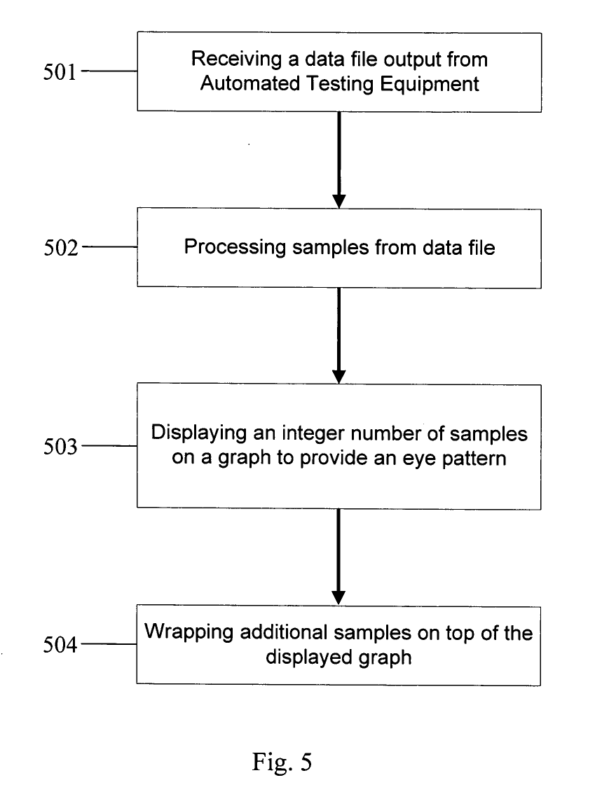

A general process of the present invention, according to at least one embodiment, is illustrated in FIG. 5. The first step, step 501, includes receiving a data file output from Automated Testing Equipment. Thereafter, in step 502, the method includes processing samples from the data file, and then, in step 503, displaying an integer number of samples on a graph to provide an eye pattern. In step 504, wrapping additional samples on top of the displayed graph occurs. The graph, as illustrated in FIG. 2, is an “eye” diagram showing the magnitude of the data samples versus a time scale. Thereafter, evaluation of the displayed eye pattern is may occur.

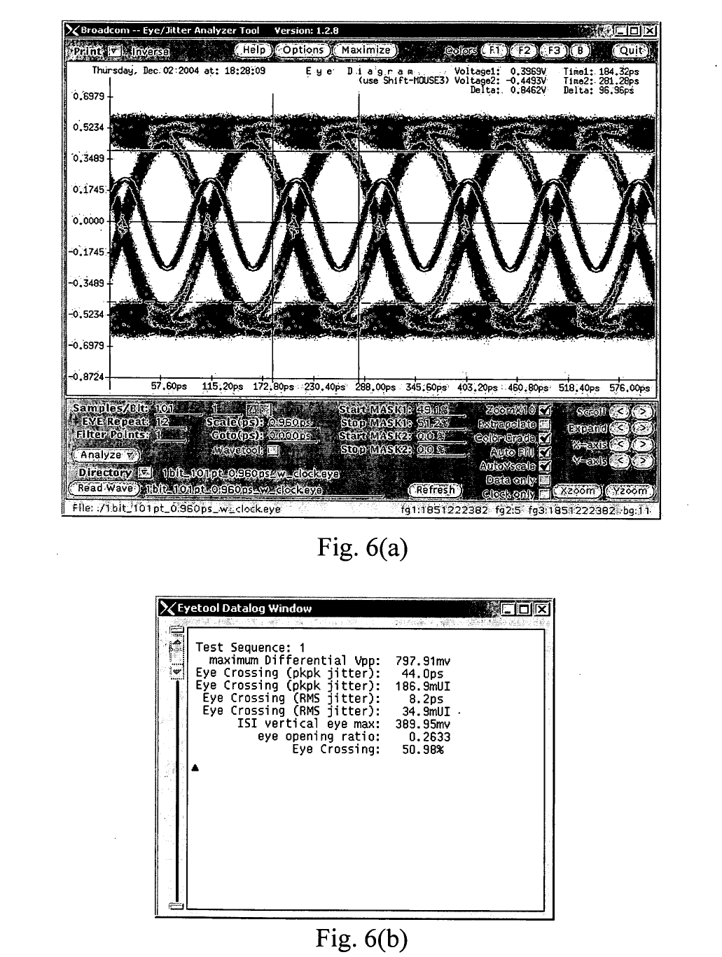

The evaluation of the data through the displayed eye pattern can take many forms. Some of the evaluations may be qualitative, such as judging whether the produced graph is what is to be expected. In other words, it is possible to determine whether the eye pattern correlates with the type of output that is anticipated. Additionally, as discussed above, the displayed data may also be used to provide specific measurements. FIG. 6(a) illustrates an eye diagram being displayed, with cross-hairs used for defining points on the display. The cross-hairs can be moved to different points on the display to fine specific points, in this case defining a time, voltage value on the graph. In one embodiment, the defined points can be used to measure jitter values, as illustrated in FIG. 6(b). As discussed above, additional measurements can be made in analogous processes.

It would also be within the scope of the invention to implement the disclosed elements of the invention in discrete electronic components, thereby taking advantage of the functional aspects of the invention. Additionally, the present invention can be implemented totally or partially through software.

Although the invention has been described based upon these preferred embodiments, it would be apparent to those skilled in the art that certain modifications, variations, and alternative constructions would be apparent, while remaining within the spirit and scope of the invention. In order to determine the metes and bounds of the invention, therefore, reference should be made to the appended claims.

1. A method for displaying data received from automated testing equipment, the method comprising the steps of:
receiving data output from automated testing equipment;
processing a predetermined integer number of samples of the received data;
displaying the predetermined integer number of samples on a graph, the graph showing magnitudes of the samples versus a time scale; and
wrapping additional samples of the received data on top of the displayed graph to provide an eye pattern;
wherein the eye pattern allows for evaluation of the data output from the automated testing equipment.

2. A method for displaying data according to claim 1, wherein the step of receiving data comprises receiving a file having ASCII values output from the automated testing equipment.

3. A method for displaying data according to claim 1, wherein the step of receiving data comprises receiving an electronic signal output from the automated testing equipment.

4. A method for displaying data according to claim 1, further comprising providing color indications in the displayed eye pattern to indicate a population of data points at a pixel position in the displayed eye pattern.

5. A method for displaying data according to claim 1, further comprising measuring values based on the displayed eye pattern in a real-time manner.

6. A method for displaying data according to claim 5, wherein the step of measuring values comprises measuring a jitter value for the data received from the automated testing equipment.

7. A method for displaying data according to claim 5, wherein the step of measuring values comprises measuring a voltage swing for the data received from the automated testing equipment.

8. A method for displaying data according to claim 1, wherein the step of wrapping additional samples comprises emulating a scanning oscilloscope.

9. A display system for data received from automated testing equipment, comprising:
receiving means for receiving data output from automated testing equipment;
processing means for processing a predetermined integer number of samples of the received data;
displaying means for displaying the predetermined integer number of samples on a graph, the graph showing magnitudes of the samples versus a time scale; and
re-displaying means for wrapping additional samples of the received data on top of the displayed graph to provide an eye pattern;
wherein the eye pattern provided by the displaying and re-displaying means allows for evaluation of the data output from the automated testing equipment.

10. A display system for displaying data according to claim 9, wherein the receiving means comprises file receiving means for receiving a file having ASCII values output from the automated testing equipment.

11. A display system for displaying data according to claim 9, wherein the receiving means comprises signal receiving means for receiving an electronic signal output from the automated testing equipment.

12. A display system for displaying data according to claim 9, further comprising means for providing color indications in the displayed eye pattern to indicate a population of data points at a pixel position in the displayed eye pattern

13. A display system for displaying data according to claim 9, further comprising measuring means for measuring values based on the displayed eye pattern in a real-time manner

14. A display system for displaying data according to claim 13, wherein the measuring means comprises measuring means for measuring a jitter value for the data received from the automated testing equipment.

15. A display system for displaying data according to claim 13, wherein the measuring means comprises measuring means for measuring a voltage swing for the data received from the automated testing equipment.

16. A display system for displaying data according to claim 9, wherein the re-displaying means is configured to emulate a scanning oscilloscope.

17. A computer program stored on a computer readable medium executable to perform method steps for displaying data received from automated testing equipment, said method steps comprising:
receiving data output from automated testing equipment;
processing a predetermined integer number of samples of the received data;
displaying the predetermined integer number of samples on a graph, the graph showing magnitudes of the samples versus a time scale; and
wrapping additional samples of the received data on top of the displayed graph to provide an eye pattern;
wherein the eye pattern allows for evaluation of the data output from the automated testing equipment.

18. A computer program according to claim 17, wherein the step of receiving data comprises receiving a file having ASCII values output from the automated testing equipment.

19. A computer program according to claim 17, wherein the step of receiving data comprises receiving an electronic signal output from the automated testing equipment.

20. A computer program according to claim 17, further comprising a step of providing color indications in the displayed eye pattern to indicate a population of data points at a pixel position in the displayed eye pattern.

21. A computer program according to claim 17, further comprising measuring values based on the displayed eye pattern in a real-time manner.

22. A computer program according to claim 21, wherein the step of measuring values comprises measuring a jitter value for the data received from the automated testing equipment.

23. A computer program according to claim 21, wherein the step of measuring values comprises measuring a voltage swing for the data received from the automated testing equipment.

24. A computer program according to claim 17, wherein the step of wrapping additional samples comprises emulating a scanning oscilloscope.
